(19) United States
(12) Patent Application Publication
(10) Pub. No.: US 2026/0351133 A1
(43) Pub. Date: Nov. 5, 2026

(54) EFFICIENCY TIPS BASED ON USER BEHAVIOR

(71) Applicant: Atieva, Inc., Newark, CA (US)

(72) Inventors: Hareesh Parepalli, Fremont, CA (US); Aijue Liu, Sunnyvale, CA (US)

(21) Appl. No.: 19/195,405

(22) Filed: Apr. 30, 2025

(51) Int. Cl. G09B 19/16; G07C 5/04; G07C 5/06

(52) U.S. Cl. CPC G09B 19/167; G07C 5/04; G07C 5/06

(57) ABSTRACT

This disclosure provides systems and methods, including computer programs encoded on storage media, method for presenting actionable suggestions. In some implementations, the method can include detecting a current behavior of a user of a vehicle by obtaining, via one or more sensors, vehicle data associated with a behavior of the user of the vehicle. Additionally, the method can include determining that the current behavior of the user of the vehicle deviates from one or more behavior patterns in an efficiency profile. The method can include quantifying energy loss associated with the current behavior of the user. The method can further include generating, based on deviation from the one or more behaviors in the efficiency profile, the one or more actionable suggestions for modifying the current behavior to more efficiently handle the vehicle. The method can furthermore include presenting the one or more actionable suggestions to the user of the vehicle.

### TECHNICAL FIELD

The present disclosure relates generally to automobiles, and more particularly, to a method and apparatus for providing efficient driving recommendations to a user of a vehicle.

### BACKGROUND

Operating an electric vehicle (EV) is a rewarding experience that combines advanced technology with environmental consciousness. Unlike traditional gasoline-powered cars, EVs are powered by electricity stored in batteries, which can be charged at home or at public charging stations. In this way, the user of the EVs do not need to make trips to the gas station. EVs are known for their smooth and quiet ride because of the absence of an internal combustion engine. Additionally, EVs offer instant torque, providing quick acceleration and a responsive driving experience. Maintaining EVs is simpler and often less expensive, as EVs have fewer moving parts and do not require oil changes.

With advancements in battery technology, range anxiety is becoming a thing of the past, as many EVs now offer substantial driving ranges on a single charge. Despite these advancements, various factors can still affect the distance an EV can travel on a single charge. For example, a lack of education on how to properly drive an EV can negatively impact its performance, primarily due to misuse of certain features and inefficient energy consumption.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In aspects of the disclosure, a method, a computer-readable medium, and an apparatus are provided. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, a method can include detecting a current behavior of a user of a vehicle by obtaining, via one or more sensors, vehicle data associated with a behavior of the user of the vehicle. The method can additionally include determining that the current behavior of the user of the vehicle deviates from one or more behavior patterns in an efficiency profile, each of the one or more behavior patterns in the efficiency profile being associated with handling the vehicle in a predefined manner that is considered efficient. In addition, the method can include generating, based on deviation from the one or more behaviors in the efficiency profile, the one or more actionable suggestions for modifying the current behavior to more efficiently handle the vehicle. The method can further include presenting the one or more actionable suggestions to the user of the vehicle.

Other embodiments of this aspect include corresponding computer systems, apparatus, and computer programs recorded on one or more computer storage devices, each configured to perform the actions of the methods.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### DESCRIPTION OF THE DRAWINGS

The present invention is illustrated by way of example and not limitation in the figures of the accompanying drawings in which like references indicate similar elements.

FIG. 1 illustrates an example operating environment in which one or more aspects of the present disclosure may operate, in accordance with some embodiments.

FIG. 2 depicts a flowchart of operational steps of a computer functions for presenting actionable suggestions, in accordance with some embodiments.

FIG. 3 illustrates an example interactive graphical user interface (GUI) for presenting actionable suggestions, in accordance with some embodiments.

FIG. 4 illustrates another example interactive GUI for presenting actionable suggestions, in accordance with some embodiments.

FIG. 5 is a data flow diagram of some embodiments of a method for presenting actionable suggestions, in accordance with some embodiments, in accordance with some embodiments.

FIG. 6 is a block diagram illustrating some embodiments of a vehicle comfort-based control system in accordance with some embodiments.

FIG. 7 illustrates system level diagram of a vehicle, in accordance with some embodiments.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” or “example” or “implementation” means that a particular feature, structure, or characteristic described in connection with the embodiment can be included in at least some embodiments of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure. The terms “electric vehicle,” “EV,” and “vehicle” may be used interchangeably and refer to an all-electric vehicle.

Energy efficiency in electric vehicles (EVs) can refer to how effectively the EVs convert stored electrical energy from the battery into usable power for driving. Several factors influence the energy efficiency of an EV, including driving habits, environmental conditions, and the efficiency of various components. Improved energy efficiency allows the EV to travel longer distances on a single charge, reducing the need for frequent charging and enhancing convenience for drivers.

Users of the EV often make mistakes related to understanding the EV's unique features, driving habits, range planning, charging habits, load management, etc. These mistakes can lead to range anxiety, shortened battery life, and missed opportunities to optimize driving and charging.

One of the common mistakes is improper use of regenerative braking feature. The regenerative braking converts braking energy back into electricity. Without proper education, drivers may not understand how to use this feature effectively, potentially losing energy that could be recovered. For example, the driver of an EV might rely too heavily on traditional braking techniques instead of allowing the regenerative braking system to slow the EV down. Traditional braking methods not only reduce the amount of energy recovered but also lead to increased wear on the brake pads.

Another common mistake is incorrect driving habits, such as hard acceleration and braking, frequent hard braking, and high-speed driving can significantly reduce EV's range. These driving habits demand additional power from the battery, leading to faster depletion.

Yet another common mistake is not maintaining the correct tire pressure of the EV. Under-inflated tires create more rolling resistance, which requires more energy to overcome, thereby reducing the EV's range. Conversely, over-inflated tires can lead to uneven wear and reduced traction.

Another one of the common mistakes is improper charging habits that can greatly affect the health and longevity of an EV's battery. Frequent use of fast chargers can lead to increased heat and stress on the battery, potentially reducing its lifespan. Additionally, not charging the battery properly, such as letting it frequently drop to very low levels or overcharging, can also negatively impact battery health.

Yet another common mistake ignoring weather conditions. Weather conditions can have a substantial impact on the performance and range of an electric vehicle. Extreme temperatures, whether hot or cold, can affect battery efficiency. Cold weather can reduce battery capacity and increase energy consumption for heating, while hot weather can lead to overheating and increased use of air conditioning.

Aspects of the present disclosure address the above-noted and other deficiencies by using an energy management system for presenting one or more actionable suggestions. Embodiments of the present disclosure describes a method based on vehicle usage patterns and route data to present a feedback (e.g.,. real-time and actionable suggestion) to the user of the vehicle (e.g., EV) when the system of the vehicle detects the behavior of the user deviates from behavior patterns in a predefined efficiency profile. For example, the behavior patterns can be associated with behaviors of handling the EV in a predefined manner that is considered efficient. Through the real-time and actionable suggestions to the user of the vehicle, for example, the method can educate user of the EV to potentially reduce the operational costs of the EV.

Embodiments of actionable suggestions can potentially improve energy consumption, allowing for extended driving range on a single charge. The actionable suggestions presented to the user can potentially increase efficiency, reducing the need for frequent charging and enhancing overall vehicle performance.

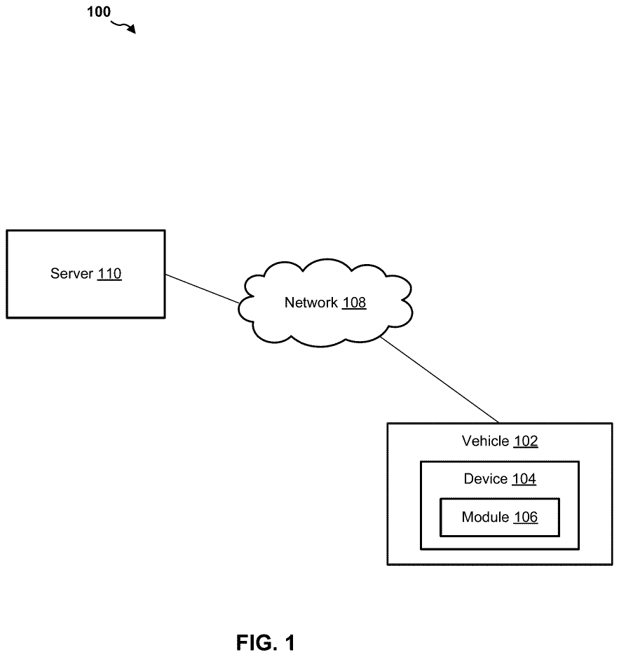

Referring now to FIG. 1, an example operating environment in which one or more aspects of the present disclosure may operate, in accordance with some embodiments. As shown, example operating environment 100 can include a vehicle 102, a network 108, and one or more servers 110.

The vehicle 102 may be communicatively coupled to the one or more servers 110 over a network 108. Network 108 may be any type of networks such as a local area network (LAN), a wide area network (WAN) such as the Internet, a cellular network, a satellite network, or a combination thereof, wired or wireless. The one or more servers 110 may be any kind of servers or a cluster of servers, such as Web or cloud servers, application servers, backend servers, or a combination thereof. The one or more servers 110 may be data analytics servers, content servers, traffic information servers, map and point of interest (MPOI) servers, or location servers, etc.

The vehicle 102 can include a device 104 (e.g., vehicle onboard computer system) with processors, memory, input/output ports, and other components that may be connected to parts of the vehicle 102. For example, the device 104 can transmit a control signal to the in-vehicle display to provide real-time information (e.g., safety alerts, warnings, system status notifications, etc.) on the dashboard or infotainment system of the vehicle. The device 104 can communicate with the one or more servers 110 over the network 108. In particular, the device 104 can transmit the received and/or processed data to the one or more servers 110.

The device 104 can be connected to one or more sensors (e.g., accelerometers, gyroscopes, brake pedal sensors, temperature sensors, pressure sensors, ride height sensors, etc.) configured to continuously monitor various aspects of the vehicle's performance and environment. The device 104 can process data from the one or more sensors and manages the vehicle system's operations. The device 104 can store the received and/or processed data in a memory of the device 104.

Additionally, the device 104 can include a module 106. The module 106 can include various analysis algorithms, program instructions, and scripts, as described herein. For example, along with the device 104, the module 106 can be configured to present one or more actionable suggestions.

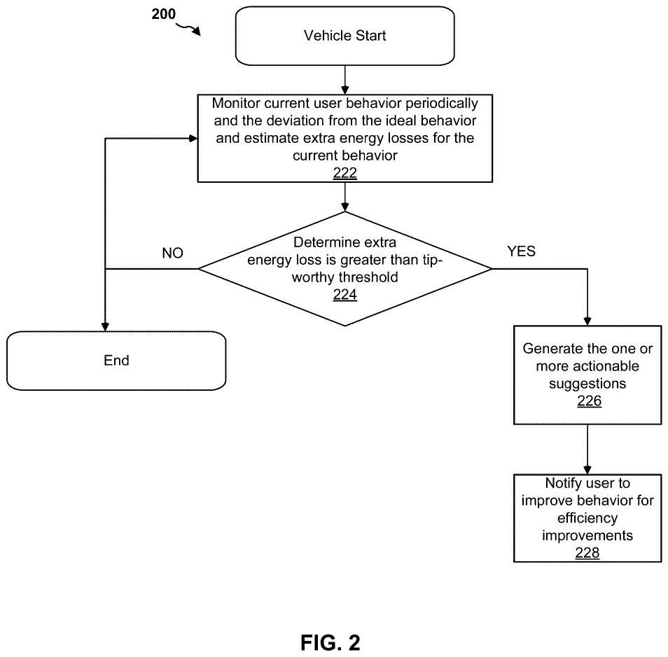

FIG. 2 depicts a flowchart of operational steps of a computer functions for presenting actionable suggestions, in accordance with some embodiments. The energy management system can be included in the module 106 or the one or more servers 110. The energy management system can be implemented by a combination of the module 106 and the device 104.

Referring to FIG. 2, beginning at block 222 of the flowchart 200, the energy management system can monitor the current user behavior periodically. In some embodiments, the energy management system detects a current behavior of a user of a vehicle by obtaining, via one or more sensors, vehicle data associated with a behavior of the user of the vehicle. For example, energy management system detects the user of the EV accelerates based on acceleration data of the EV via accelerometers, speed sensors, throttle position sensors, gyroscopes, etc. The accelerometer, for example, can detect the rapid increase in speed when the user of the EV presses the accelerator pedal. Note that other sensors capable of detecting the current behavior of the user of the vehicle can be used in conjunction with the energy management system and method of the techniques disclosed herein.

In some embodiments, the energy management system detects the current behavior of the user of the vehicle is based on at least one of: a braking pattern, an acceleration pattern, a first period of time when operating the vehicle over a current speed limit, a second period of time when operating the vehicle with a current ride height setting, a third period of time when operating the vehicle with a current tire pressure, a fourth period of time when operating the vehicle with a current climate setting, a battery-charging mode selected by the user, a change in standard operating features, weather information, and route information. The energy management system can detect the change in standard operating features when the user of the EV makes any significant vehicle modifications such as attaching a trailer to the EV, opening the windows, adding the vehicle mass (e.g., having additional passengers), mounting a bike rack, etc.

The energy management system can monitor the deviation from the ideal behavior and estimate extra energy losses for the current behavior. For example, when the user of the EV relies on traditional friction brakes instead of the regenerative braking feature of the EV, the kinetic energy can be converted into heat and loss. This improper use of the regenerative braking feature can lead to an energy loss, reducing the EV's efficiency and increasing energy consumption. The energy management system can quantify the energy loss associated with the current behavior of the user of the EV. For example, the energy management system determines the user of the EV can drive an additional number of miles during the trip with the energy recovered through proper use of the regenerative braking feature. In some other example, the user of the EV can gain financial savings (e.g., save approximately few hundred dollars) during the trip by using the regenerative braking feature properly. By highlighting and presenting these quantification of energy losses to the user via a visual representation, for example, the energy management system can motivate the user of the EV to adjust their current behavior (e.g., properly use the regenerative braking) that can potentially extend the driving range of the EV and save money.

In some embodiments, the energy management system determines that the current behavior of the user of the vehicle deviates from one or more behavior patterns in an efficiency profile. Each of the one or more behavior patterns in the efficiency profile is associated with handling the vehicle in a predefined manner that is considered efficient. For example, the energy management system determines the user of the EV is operating the EV at a speed of 75 mile per hour (mph) while the speed limit of the area is 60 mph. The energy management system monitors the time spent by the user of the EV driving over the speed limit.

In some embodiments, the energy management system monitors the user braking behavior and compares the user braking behavior against the ideal braking behavior for the current drive to determine the missed recuperation energy. In some embodiments, the energy management system monitors the user acceleration behavior and compares the user acceleration behavior against the ideal acceleration behavior for the current drive to determine the extra energy used. In some embodiments, the energy management system monitors the time spent speeding over the speed limit and determines the extra energy used to maintain speed above the limit. In some embodiments, the energy management system monitors the time spent driving with the current ride height setting and estimates the extra energy used due to deviation from the ideal ride height. In some embodiments, the energy management system monitors the user's driving behavior, estimate the range on arrival, and determine the speed limit below which the range on arrival remains positive to ensure reachability. In some embodiments, the energy management system monitors the time spent driving with the current tire pressure and estimates the extra energy used due to deviation from the ideal tire pressure. In some embodiments, the energy management system monitors the time spent with the current climate settings and estimates the extra energy used due to deviation from the ideal climate settings. In some embodiments, the energy management system monitors the charging behavior and presents the actionable suggestion for overall improvement in battery health and reduced charging times. In some embodiments, the energy management system monitors any modification to the vehicle standard operating features such as trailer attached, windows open, vehicle mass increased, bike racks mounted etc. and educate user of the efficiency changes due to these modifications. In some embodiments, the energy management system monitors the effects of wind and terrain for a route to educate the user about the extra energy needed to overcome these additional forces.

In some embodiments, the energy management system estimates the extra energy losses for the current behavior of the user of the vehicle. Based on the estimated extra energy losses, the energy management system can determine the mile-saving suggestion that corresponds to the estimated energy loss. For example, the energy management system determines the energy loss is approximately 200 Kilojoule (kJ) if the user of the vehicle does not properly use the regenerative feature. Based on the approximated energy loss, the energy management system determines the user of the EV can drive an additional number of miles during a trip with the energy recovered through proper use of the regenerative braking feature.

At block 224, the energy management system can determine whether the extra energy loss is greater than tip-worthy threshold. In some embodiments, the energy management system estimates the extra energy losses associated with the current behavior of the user. In some embodiments, the energy management system determines the energy loss is approximately 200 kJ if the user of the vehicle does not properly use the regenerative feature. The energy management system can compare the energy loss to a predefined threshold. For example, the energy management system determines the energy loss of 200 kJ is greater than the threshold of 150 kJ. In some other embodiments, in a scenario where the user is driving above a speed limit, the energy management system determines the extra energy loss (e.g., approximately 100 kJ) to maintain speed above the speed limit.

In some embodiments, if the energy management system determines that extra energy loss associated with a difference between the current behavior of the user and at least one of the one or more behavior patterns of the efficiency profile are greater than a threshold, the flowchart 200 proceeds to block 226. For example, the energy management system determines threshold which can be used to compare to the extra energy loss when the user of the vehicle maintains a speed above the speed limit. mph.

In some embodiments, the energy management system calculates potential losses associated with the current behavior of the user of the vehicle. For example, the energy management system calculates the amount of energy consumed associated with the aggressive acceleration.

In some embodiments, the energy management system quantifies possible energy savings associated with the one or more actionable suggestions. For example, the energy management system determines a number of miles that could have been saved on the particular trip when the user of the EV practices a smoother acceleration.

At block 226, the energy management system can generate the one or more actionable suggestions. In some embodiments, the energy management system generates, based on deviation from the one or more behaviors in the efficiency profile, the one or more actionable suggestions for modifying the current behavior to more efficiently handle the vehicle. In some embodiments, the one or more actionable suggestions include at least one of: energy-saving recommendation, mile-saving recommendation, battery-charging mode alternative, environmentally saving recommendation; cost-saving recommendation, and educational content associated with the current behavior of the user of the vehicle. For example, the actionable suggestion can include “using regenerative braking more efficiently could have saved you predetermined miles on this drive.” Other examples of actionable suggestions can include “smoother acceleration could have saved you a predetermined number of miles on this drive;” “driving below a predetermined speed could have saved you a predetermined number of miles on this drive;” “setting the ride height to low could have saved you a predetermined number of miles on this drive;” “driving below a predetermined speed is recommended to reach your destination;” “filling your tires to a predetermined air pressure could have saved you a predetermined number of miles on this drive;” “setting your cabin temperature to a predetermined temperature could have saved you a predetermined number of miles on this drive;” “preconditioning your battery for fast charging could have saved you a predetermined number of minutes of charge time;” recommending using slow charging for the next charge session; and indicating that “predetermined wind speed along the route could cost more than a predetermined number of miles this route.”

At block 228, the energy management system can notify the user to improve behavior for efficiency improvements. In some embodiments, the energy management system presents the one or more actionable suggestions to the user of the vehicle. For example, the energy management system generates a visual feedback (e.g., graphical user interface, notification, message, etc.) to be displayed on the dashboard or infotainment system, providing actionable suggestions to the user of the vehicle. In some embodiments, the energy management system projects the actionable suggestions onto the windshield, allowing the user of the vehicle to see the actionable suggestions without taking their eyes off the road. In some other embodiments, the energy management system displays intuitive icons and lights on the dashboard that convey the actionable suggestions quickly and clearly. In some embodiments, the energy management system presents the one or more actionable suggestions to the user of the vehicle via auditory output. For example, the energy management system generates soft and non-intrusive sounds that alert the user of the EV to the arrival of the notification of the actionable suggestions. In some other example, the energy management system generates spoken notifications that provide the actionable suggestions without requiring visual attention. In some embodiments, the energy management system presents the one or more actionable suggestions to the user of the vehicle via a GUI combined with auditory feedback, haptic feedback, ambient lighting, etc. For example, in response to determining that the user of the EV operating the EV at a speed of 10 mile per hour (mph) over the speed limit, the energy management system displays on the GUI the savings of driving below the speed limit. Concurrently, the energy management system can display the current speed and the speed limit with a subtle highlight, a brief beep, and a change of the cabin ambient lighting to yellow.

In some embodiments, the energy management system integrates data from driving assistance systems to determine the timing of the presentation of the one or more actionable suggestions. For example, if the EV detects heavy traffic, the energy management system can adjust the timing (e.g., delay the timing) of the presentation of the one or more actionable suggestions until the EV detects the traffic has eased.

Note that other notification mechanism capable of presenting the one or more actionable suggestions can be used in conjunction with the system and method of the present disclosure.

In some embodiments, the energy management system displays guided information associated with the one or more actionable suggestions to enable the user to handle the vehicle in a manner that achieves a target efficiency for the vehicle. For example, the energy management system can display the actionable suggestion “using regenerative braking more efficiently could have saved you xx miles on this drive” when the energy management system detects the user of the EV deviates from one or more behavior patterns in an efficiency profile. In addition to the display of the actionable suggestion, the energy management system can display a regenerative braking icon on the dashboard when the user of the EV starts applying the regenerative braking. The icon can change color or intensity based on the level of regenerative braking being applied by the user of the EV. The energy management system can also display a real-time energy flow diagram on the infotainment screen, illustrating how energy is being recaptured during braking.

In some embodiments, the energy management system automatically implements the one or more actionable suggestions based on at least one of: feedback by the user, and a current driving mode of the vehicle. For example, as described above, the energy management system can engage a regenerative braking when the user of the EV starts applying the regenerative braking. In another example, the energy management system can engage a regenerative braking when the user of the EV provides an input (e.g., pressing an automatic regenerative braking icon) to the system. In another example, the energy management system can engage a regenerative braking if the EV is currently on an eco-mode.

In some embodiments, the one or more actionable suggestions to the user of the vehicle are for at least one of: a current trip; and past trips. For example, the energy management system can display the actionable icon “filling your tires to xx kPa could have saved you xx miles” for this drive. In another example, the energy management system can display a dedicated section in the infotainment system where the user of the EV can view the summary of the past trips, highlighting the potential mileage savings for each past trip if the user has applied regenerative braking properly. In a further example, the energy management system can display graphs showing the amount of energy recaptured through regenerative braking over time, comparing different trips.

In some embodiments, the efficiency profile includes an estimated energy consumption of at least one of the one associated with the behavior of the user of the vehicle. For example, setting the cabin temperature at 70 Fahrenheit (F) in cold weather can significantly increase energy consumption, as electric heaters draw power directly from the battery.

In some embodiments, the energy management system generates the efficiency profile based on at least one of: a machine learning model, and a physics-based model. For example, a trained machine learning model predicts the HVAC system uses a significant energy to cool the cabin to 70 F in warmer weather as the air conditioning systems draw power from the battery.

In some embodiments, the energy management system determines a first threshold based on at least one of: the machine learning model, and group vehicle data associated with group of vehicles. The first threshold represents a value that triggers the generating the one or more actionable suggestions. For example, the energy management system determines the threshold using a trained machine learning model. In another example, the energy management system determines the threshold based on data collected from a group of EVs.

In some embodiments, the energy management system receives feedback from the user in response to the one or more actionable suggestions; and updates the machine learning model based on the feedback. For example, the user of the EV starts applying the regenerative braking after reviewing the actionable suggestion on the GUI. The energy management system uses this user feedback as training data to update the existing machine learning model.

In some embodiments, the energy management system determines, using the machine learning model, timing and content of the one or more actionable suggestions based on a user responsiveness of the feedback achieving a second threshold. The energy management system can determine the timing of the content of the one or more actionable suggestions based on the training data (e.g., driver behavior data that describe how the driver responds to different timing and contents of notifications, driving patterns, and preferences) that are used to train the machine learning model. To further train the machine learning model, the energy management system can also collect other training data including time data (e.g., the time when notifications are presented, etc.), vehicle data (e.g., data from the EV's sensors, including speed, battery level, driving patterns, etc.), weather data (e.g., environmental conditions, etc.), traffic data (e.g., real-time traffic information, including congestion levels and road conditions, etc.), historical data (e.g., past data on notifications, including timing, content, and driver responses, etc.), driver state data (e.g., whether the user is focused distracted, or fatigued, etc.).

In some embodiments, based on the driver state data, the energy management system determines the one or more actionable suggestions are presented when the driver is most alert, typically during the day and not during late-night hours. In some embodiments, based on the traffic data and vehicle data, the energy management system determines to avoid presenting the one or more actionable suggestions during complex driving maneuvers or high-stress situations, such as heavy traffic or navigating through intersections. In some embodiments, based on the vehicle data, the energy management system determines to avoid presenting the one or more actionable suggestions when the EV is accelerating or decelerating rapidly, as these moments require the user's full attention. In some embodiments, based on the weather data, the energy management system determines to avoid presenting the one or more actionable suggestions during bad weather conditions that might require the user's full attention, such as rain or fog. If the energy management system determines that the extra energy loss is less than tip-worthy threshold, the flowchart 200 proceeds to block 222.

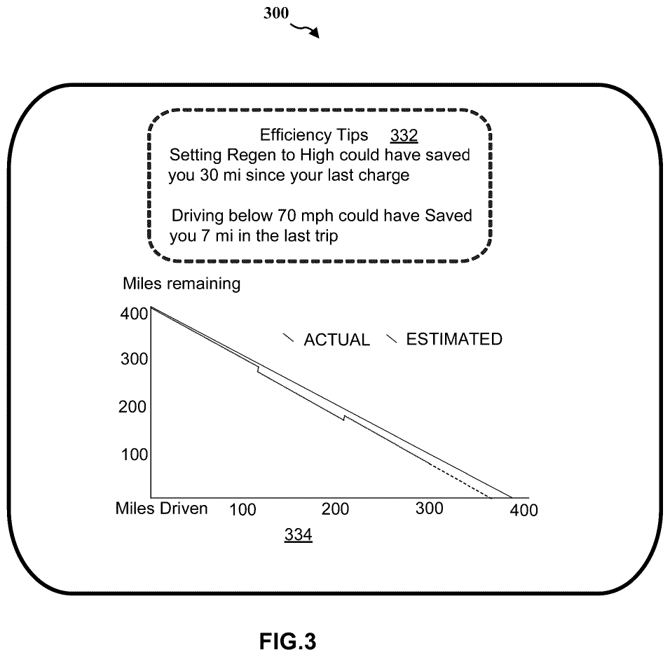

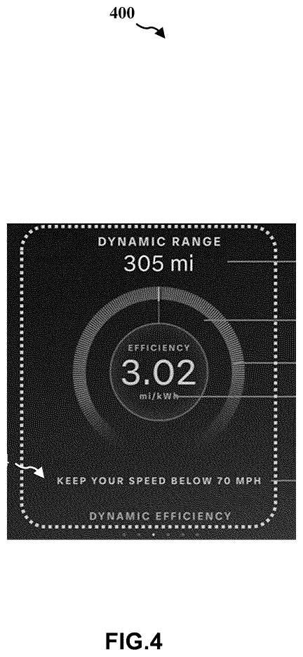

FIGS. 3 and 4 illustrate an automotive screen system displaying exemplary GUIs on display screens using the techniques disclosed herein. FIG. 3 illustrates an example interactive GUI for presenting actionable suggestions, in accordance with some embodiments. Referring to FIG. 3, the GUI 300 can be divided into multiple regions including region 332 and region 334.

The GUI 300 can include a region 332 displaying the one or more actionable suggestions. For example, a user of the EV is commuting though an urban area with frequent stop-and-go-traffic. The user of the EV may rely on traditional friction brakes by engaging in frequent and abrupt braking, which can reduce the efficiency of the energy recovery. The energy management system detects the user of the EV engages frequent braking. As shown in FIG. 3, the energy management system presents the actionable suggestion to the user by displaying “Setting Regen to High could have saved you 30 mi since your last charge” in the region 332. In another example, the energy management system detects the user of the EV operates the EV at a speed above 70 mph which deviates from behavior patterns associated with handling the EV in a predefined manner that is considered efficient. In response, the energy management system presents the actionable suggestion to the user by displaying “Driving below 70 mph could have saved you 7 mi in the last trip” in the region 332.

The GUI can include a region 332 displaying a visual comparison between the estimated range and actual miles driven. As illustrated in FIG. 3, a line graph shows the decline in estimated range over time compared to the actual miles driven. In some embodiments, the region 334 can display color coded visual comparison to distinguish between estimated and actual miles (e.g., blue for estimated, green for actual).

FIG. 4 illustrates another example interactive GUI for presenting actionable suggestions, in accordance with some embodiments. Referring to FIG. 4, the GUI 400 can include a display providing real-time feedback and information about the vehicle's performance and energy consumption. As shown, the GUI 400 can also include a notification 434 that presents the actionable suggestions to the user of the vehicle. For example, as described in connection with FIG. 3, the energy management system detects the user of the EV operates the EV at a speed above 70 mph which deviates from behavior patterns associated with handling the EV in a predefined manner that is considered efficient. In response, the energy management system presents the actionable suggestion to the user by displaying notification 434 “Keep Your Speed Below 70 mph”.

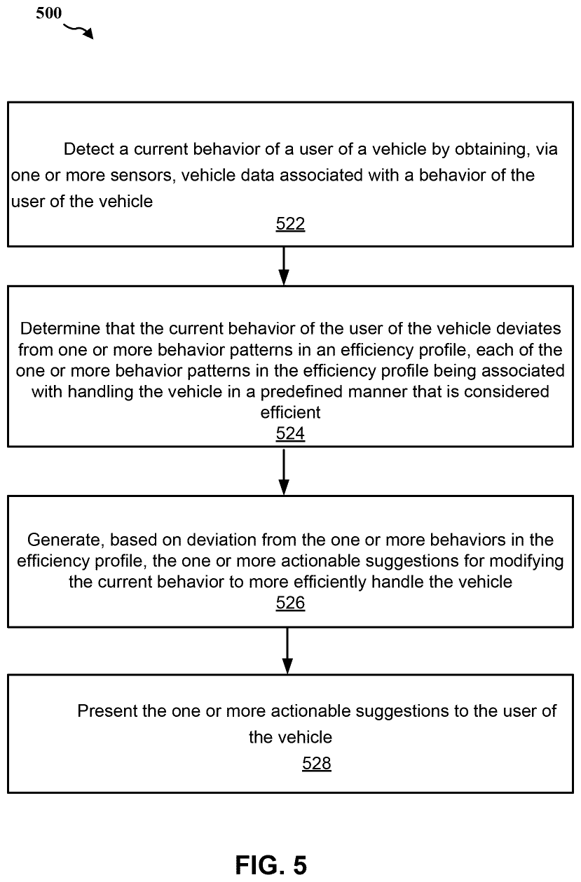

FIG. 5 is a data flow diagram of some embodiments of a method of a vehicle comfort-based control system for controlling vent settings of a vehicle in accordance with some embodiments. The method may be performed by processing logic that may comprise hardware (e.g., circuitry, dedicated logic, programmable logic, a processor, a processing device, a CPU, a system-on-chip, etc.), software (e.g., instructions running/executing on a processing device), firmware (e.g., microcode), or a combination thereof. In some embodiments, at least a portion of the method may be performed based on aspects of FIGS. 1-4.

With reference to FIG. 5, the method illustrates example functions used by various embodiments. Although specific function blocks (“blocks”) are disclosed in the method, such blocks are examples. That is, embodiments are well suited to performing various other blocks or variations of the blocks recited in the method. It is appreciated that the blocks in the method may be performed in an order different than presented, and that not all of the blocks in the method may be performed.

The method begins at block 522, where processing logic detects a current behavior of a user of a vehicle by obtaining, via one or more sensors, vehicle data associated with a behavior of the user of the vehicle. For example, referring to FIG. 2, the energy management system can detect the user of the EV presses the accelerator pedal via accelerometers, speed sensors, throttle position sensors, gyroscopes, etc.), as described above.

As also shown in FIG. 5, at block 524, processing logic determines that the current behavior of the user of the vehicle deviates from one or more behavior patterns in an efficiency profile, each of the one or more behavior patterns in the efficiency profile being associated with handling the vehicle in a predefined manner that is considered efficient. For example, referring to FIG. 2, the energy management system detects the user of the EV does not properly use the regenerative feature and relies on the traditional friction brakes. As a result, the energy management system determines the energy loss is approximately 200 kJ because the user of the EV does not properly use the regenerative feature.

As further shown in FIG. 5, at block 526, processing logic generates, based on deviation from the one or more behaviors in the efficiency profile, the one or more actionable suggestions for modifying the current behavior to more efficiently handle the vehicle. For example, referring to FIG. 2, the actionable suggestion can include using regenerative braking more efficiently could have saved the user of the EV a predetermined miles on this drive, as described above.

As additionally shown in FIG. 5, at block 528, processing logic presents the one or more actionable suggestions to the user of the vehicle. For example, referring to FIG. 3, the energy management system generates a visual feedback (e.g., graphical user interface, notification, message, etc.) to be displayed on the dashboard or infotainment system, providing actionable suggestions to the user of the vehicle, as described above. As described in connection with FIG. 2, the energy management system quantifies the possible energy losses associated with the current behavior of the user, and presents the possible energy losses to the user via the actionable suggestions. In one example, the user can drive an additional number of miles during the trip with the energy recovered through proper use of the regenerative braking feature. In another example, the user of the EV can save approximately few hundred dollars during the trip by using regenerative braking properly. By presenting these quantification of energy losses via the actionable suggestions, the energy management system can motivate the user to adjust their current behavior (e.g., properly use the regenerative braking) that can potentially extend the driving range of the EV and save money.

Although FIG. 5 shows example blocks of data flow diagram 500, in some implementations, data flow diagram 500 may include additional blocks, fewer blocks, different blocks, or differently arranged blocks than those depicted in FIG. 5. Additionally, or alternatively, two or more of the blocks of data flow diagram 500 may be performed in parallel.

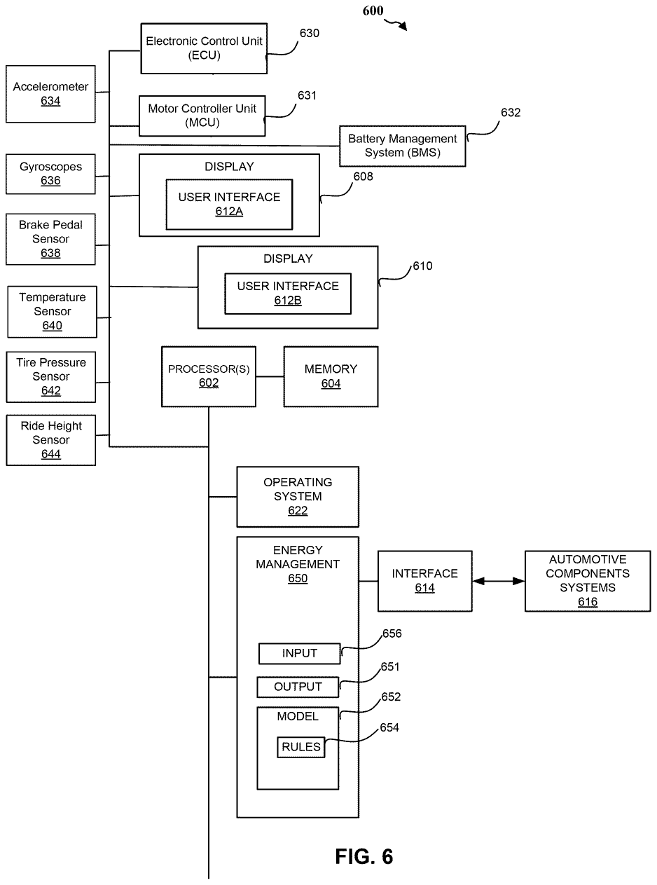

FIG. 6 is a block diagram 600 illustrating some embodiments of a vehicle comfort-based control system in accordance with some embodiments. One or more processors 602 coupled to memory 604 perform processing duties according to various software, hardware, firmware, or combination modules. The processor(s) 602 and memory 604 are coupled to an electronic control unit (ECU) 630, a motor controller unit (MCU) 631, a battery management system (BMS) 632, an accelerometer 634, gyroscopes 636, brake pedal sensors 638, temperature sensors 640, tire pressure sensors 642, ride height sensors 644, a first display 608 (e.g., having a display screen) on which a user interface 612A is displayed, a second display 610 on which a user interface 612B is displayed.

Also, the processor(s) 602 and memory 604 are coupled to an operating system 622 and an energy management 650. The energy management 650 has an input module 656, and output module 651, and in some embodiments includes a model 652 with rules 654. Other forms of models may be used in some embodiments. The energy management 650 can be coupled to an interface 614 which can be coupled to automotive components and systems 616 in order to control, adjust or otherwise provide input to such components and systems. Automotive components and systems 616 can include output operations (e.g., display, notification operations, general feedback, general interface operations, etc.), One form of implementation is special programming of the system, more specifically special programming of the processor(s) 602. It should be appreciated that structure of the various modules is determined by their functionality, in some embodiments.

In an operating scenario, which describes functionality of some embodiments, a current behavior of a user of a vehicle is detected by obtaining, via one or more sensors, vehicle data associated with a behavior of the user of the vehicle. The vehicle data associated with a behavior of the user of the vehicle is detected by the one or more sensors (e.g., an accelerometer 634, gyroscopes 636, brake pedal sensors 638, temperature sensors 640, tire pressure sensors 642, ride height sensors 644, etc.), as described above. The energy management 650 determines that the current behavior of the user of the vehicle deviates from one or more behavior patterns in an efficiency profile, each of the one or more behavior patterns in the efficiency profile being associated with handling the vehicle in a predefined manner that is considered efficient. The energy management 650 generates, based on deviation from the one or more behaviors in the efficiency profile, the one or more actionable suggestions for modifying the current behavior to more efficiently handle the vehicle, as described above. The energy management 650 presents the one or more actionable suggestions to the user of the vehicle via user interface 612A, 612B, automotive component systems 616, etc. All of the above is coordinated through the operating system 622, which may be a real-time operating system. It should be appreciated that the energy management 650 may be integrated with or part of the operating system 622, in some embodiments.

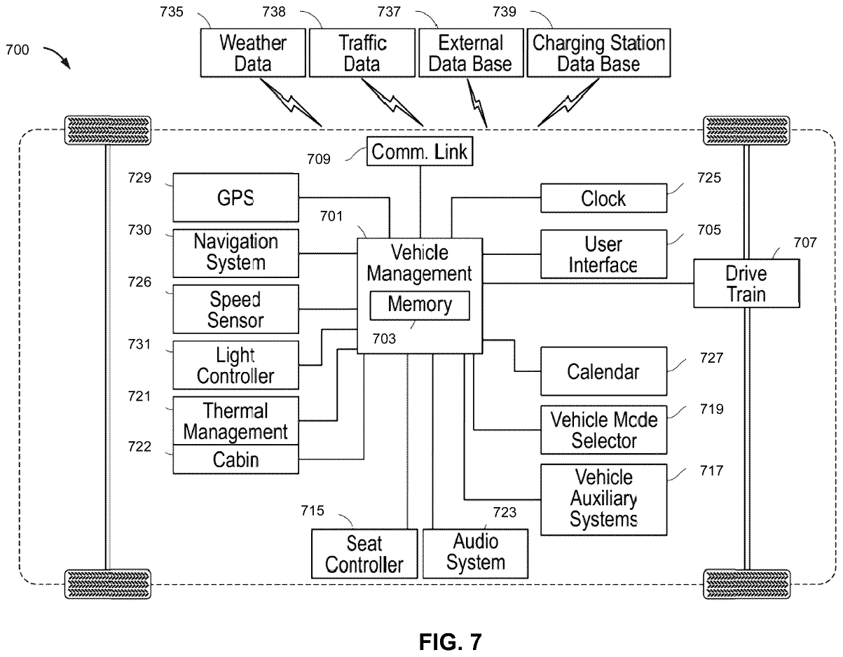

FIG. 7 is a high-level view of some embodiments of a vehicle 700. Vehicle 700 can be an electric vehicle (EV), a vehicle utilizing an internal combustion engine (ICE), or a hybrid vehicle, where a hybrid vehicle utilizes multiple sources of propulsion including an electric drive system. Vehicle 700 includes vehicle management 701 which is comprised of a processor (e.g., a central processing unit (CPU)). The vehicle management 701 also includes memory 703, with memory 703 being comprised of EPROM, EEPROM, flash memory, RAM, solid state drive, hard disk drive, or any other type of memory or combination of memory types. It should be understood that the terms “vehicle management system,” “system controller” and “vehicle on-board system controller” can be used interchangeably throughout this disclosure. A user interface 705 is coupled to the vehicle management 701. User interface 705 allows the driver, or a passenger, to interact with the vehicle management system, for example inputting data into the navigation system 730, altering the heating, ventilation and air conditioning (HVAC) system via the thermal management system 721, controlling the vehicle's entertainment system (e.g., radio, CD/DVD player, etc.), adjusting vehicle settings (e.g., seat positions, light controls, etc.), and/or otherwise altering the functionality of vehicle 700. In at least some embodiments, user interface 705 also includes means for the vehicle management system to provide information to the driver and/or passenger, information such as a navigation map or driving instructions (e.g., via the navigation system 730 and GPS system 729) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 726), current HVAC settings such as cabin temperature and/or fan settings, etc.) via the thermal management system 721. User interface 705 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 700 can also include other features like an internal clock 725 and a calendar 727.

In some embodiments, user interface 705 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 705 includes a graphical display, the vehicle management 701 may also include a graphical processing unit (GPU), with the GPU being either separate from or contained on the same chip set as the processor.

Vehicle 700 also includes a drive train 707 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip).

Drivers often alter various vehicle settings, either when they first enter the car or while driving, in order to vary the car to match their physical characteristics, their driving style and/or their environmental preferences. The vehicle management 701 monitors various vehicle functions that the driver may use to enhance the fit of the car to their own physical characteristics, such as seat position (e.g., seat position, seat height, seatback incline, lumbar support, seat cushion angle and seat cushion length) using seat controller 715 and steering wheel position using an auxiliary vehicle system controller 717. In some embodiments, the vehicle management 701 also can monitor a driving mode selector 719 which is used to control performance characteristics of the vehicle (e.g., economy, sport, normal). In some embodiments, the vehicle management 701 can also monitor suspension characteristics using auxiliary vehicle system controller 717, assuming that the suspension is user adjustable. In some embodiments, the vehicle management 701 also monitors those aspects of the vehicle which are often varied by the user in order to match his or her environmental preferences for the cabin 722, for example setting the thermostat temperature or the recirculation controls of the thermal management system 721 that uses an HVAC controller, and/or setting the radio station/volume level of the audio system using controller 723, and/or setting the lights, either internal lighting or external lighting, using light controller 731. Also, besides using user-input and on-board sensors, the vehicle management 701 can also use data received from an external on-line source that is coupled to the controller via communication link 709 (using, for example, GSM, EDGE, UMTS, CDMA, DECT, WiFi, WiMax, etc.). For example, in some embodiments, the vehicle management 701 can receive weather information using an on-line weather service 735 or an on-line data base 737, traffic data 738 for traffic conditions for the navigation system 730, charging station locations from a charging station database 739, etc.

As an example, upon turning on the vehicle 700, in some embodiments, the vehicle management 701 identifies the current driver (and go to their last pre-set functions) or just go the last pre-set functions for the vehicle (independent of who the current driver is), related to such features as: media functions, climate functions-heating, ventilation and air conditioning (HVAC) system, driving functions, seat positioning, steering wheel positioning, light control (e.g., internal lighting, external lighting, etc.), navigation functions, etc. Note that for purposes herein, the techniques will be described with reference to capacitive controllers. Even so, the techniques are not limited to the capacitive controllers and can be employed with other types of controllers.

Detailed illustrative embodiments are disclosed herein. However, specific functional details disclosed herein are merely representative for purposes of describing embodiments. Embodiments may, however, be embodied in many alternate forms and should not be construed as limited to only the embodiments set forth herein.

It should be understood that although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

With the above embodiments in mind, it should be understood that the embodiments might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing. Any of the operations described herein that form part of the embodiments are useful machine operations. The embodiments also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

A module, an application, a layer, an agent, or other method-operable entity could be implemented as hardware, firmware, or a processor executing software, or combinations thereof. It should be appreciated that, where a software-based embodiment is disclosed herein, the software can be embodied in a physical machine such as a controller. For example, a controller could include a first module and a second module. A controller could be configured to perform various actions, e.g., of a method, an application, a layer, or an agent.

The embodiments can also be embodied as computer readable code on a tangible non-transitory computer readable medium. The computer readable medium is any data storage device that can store data, which can be thereafter read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion. Embodiments described herein may be practiced with various computer system configurations including hand-held devices, tablets, microprocessor systems, microprocessor-based or programmable consumer electronics, minicomputers, mainframe computers and the like. The embodiments can also be practiced in distributed computing environments where tasks are performed by remote processing devices that are linked through a wire-based or wireless network.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

In some embodiments, one or more portions of the methods and mechanisms described herein may form part of a cloud-computing environment. In such embodiments, resources may be provided over the Internet as services according to one or more various models. Such models may include Infrastructure as a Service (IaaS), Platform as a Service (PaaS), and Software as a Service (SaaS). In IaaS, computer infrastructure is delivered as a service. In such a case, the computing equipment is generally owned and operated by the service provider. In the PaaS model, software tools and underlying equipment used by developers to develop software solutions may be provided as a service and hosted by the service provider. SaaS typically includes a service provider licensing software as a service on demand. The service provider may host the software, or may deploy the software to a customer for a given period of time. Numerous combinations of the above models are possible and are contemplated.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method for presenting one or more actionable suggestions, comprising:
detecting a current behavior of a user of a vehicle by obtaining, via one or more sensors, vehicle data associated with a behavior of the user of the vehicle;
determining that the current behavior of the user of the vehicle deviates from one or more behavior patterns in an efficiency profile, each of the one or more behavior patterns in the efficiency profile being associated with handling the vehicle in a predefined manner that is considered efficient;
generating, based on deviation from the one or more behavior patterns in the efficiency profile, the one or more actionable suggestions for modifying the current behavior to more efficiently handle the vehicle; and
presenting the one or more actionable suggestions to the user of the vehicle.

2. The method of claim 1, wherein determining that the current behavior of the user of the vehicle deviates from one or more behavior patterns in an efficiency profile comprises determining that extra energy loss associated with a difference between the current behavior of the user and at least one of the one or more behavior patterns of the efficiency profile are greater than a threshold.

3. The method of claim 2, further comprising estimating extra energy losses associated with the current behavior of the user.

4. The method of claim 1, wherein determining that the current behavior of the user of the vehicle deviates from one or more behavior patterns in an efficiency profile comprises: calculating potential losses associated with the current behavior of the user of the vehicle, or quantifying possible energy savings associated with the one or more actionable suggestions.

5. The method of claim 1, wherein the one or more actionable suggestions include at least one of:
energy-saving recommendation;
mile-saving recommendation;
battery-charging mode alternative;
environmentally saving recommendation; and
educational content associated with the current behavior of the user of the vehicle.

6. The method of claim 1, wherein detecting the current behavior of the user of the vehicle is based on at least one of:
a braking pattern,
an acceleration pattern,
a first period of time when operating the vehicle over a current speed limit,
a second period of time when operating the vehicle with a current ride height setting,
a third period of time when operating the vehicle with a current tire pressure,
a fourth period of time when operating the vehicle with a current climate setting,
a battery-charging mode selected by the user,
a change in standard operating features,
weather information, and
route information.

7. The method of claim 1, further comprising:
displaying guided information associated with the one or more actionable suggestions to enable the user to handle the vehicle in a manner that achieves a target efficiency for the vehicle.

8. The method of claim 1, wherein the one or more actionable suggestions are presented to the user of the vehicle via at least one of:
a graphical user interface (GUI), and
an auditory output.

9. The method of claim 1, further comprising:
automatically implementing the one or more actionable suggestions based on at least one of:
feedback by the user, and
a current driving mode of the vehicle.

10. The method of claim 1, wherein the one or more actionable suggestions to the user of the vehicle are for at least one of:
a current trip; and
past trips.

11. The method of claim 1, wherein the efficiency profile includes an estimated energy consumption of at least one of the one associated with the behavior of the user of the vehicle.

12. The method of claim 1, further comprising generating the efficiency profile based on at least one of:
a machine learning model, and
a physics-based model.

13. The method of claim 12, further comprising:
determining a first threshold based on at least one of:
the machine learning model, and
group vehicle data associated with group of vehicles, wherein the first threshold represents a value that triggers the generating the one or more actionable suggestions.

14. The method of claim 13, further comprising:
receiving feedback from the user in response to the one or more actionable suggestions; and
updating the machine learning model based on the feedback.

15. The method of claim 14, further comprising:
determining, using the machine learning model, timing and content of the one or more actionable suggestions based on a user responsiveness of the feedback achieving a second threshold.

16. A vehicle, comprising:
a control system including:
a processor,
a memory coupled to the processor to store instructions, which when executed by the processor, cause the processor to perform operations, the operations comprising:
detecting a current behavior of a user of a vehicle by obtaining, via one or more sensors, vehicle data associated with a behavior of the user of the vehicle;
determining that the current behavior of the user of the vehicle deviates from one or more behavior patterns in an efficiency profile, each of the one or more behavior patterns in the efficiency profile being associated with handling the vehicle in a predefined manner that is considered efficient;
generating, based on deviation from the one or more behavior patterns in the efficiency profile, one or more actionable suggestions for modifying the current behavior to more efficiently handle the vehicle; and
presenting the one or more actionable suggestions to the user of the vehicle.

17. The vehicle of claim 16, wherein determining that the current behavior of the user of the vehicle deviates from one or more behavior patterns in an efficiency profile comprises determining that extra energy loss associated with a difference between the current behavior of the user and at least one of the one or more behavior patterns of the efficiency profile are greater than a threshold.

18. The vehicle of claim 17, further comprising estimating extra energy losses associated with the current behavior of the user.

19. The vehicle of claim 16, wherein determining that the current behavior of the user of the vehicle deviates from one or more behavior patterns in an efficiency profile comprises:
calculating potential losses associated with the current behavior of the user of the vehicle, or
quantifying possible energy savings associated with the one or more actionable suggestions.

20. A non-transitory machine-readable storage medium having instructions stored therein, which when executed by a processor, cause the processor to perform operations, the operations comprising:
detecting a current behavior of a user of a vehicle by obtaining, via one or more sensors, vehicle data associated with a behavior of the user of the vehicle;
determining that the current behavior of the user of the vehicle deviates from one or more behavior patterns in an efficiency profile, each of the one or more behavior patterns in the efficiency profile being associated with handling the vehicle in a predefined manner that is considered efficient;
generating, based on deviation from the one or more behavior patterns in the efficiency profile, one or more actionable suggestions for modifying the current behavior to more efficiently handle the vehicle; and
presenting the one or more actionable suggestions to the user of the vehicle.
